(19) United States
(12) Patent Application Publication
(10) Pub. No.: US 2017/0024749 A1
(43) Pub. Date: Jan. 26, 2017

(54) SYSTEM AND METHOD FOR DETERMINING TARGETED PATHS BASED ON INFLUENCE ANALYTICS

(71) Applicant: Concert7, Tortola (GB)

(72) Inventors: Ramasubramaniam Barathy, Dubai (AE); Subhra Jyoti Das, Dubai (AE)

(21) Appl. No.: 14/807,085

(22) Filed: Jul. 23, 2015

(51) Int. Cl. G06Q 30/02

(52) U.S. Cl. CPC G06Q 30/0201; G06Q 30/0277; G06Q 50/01

(57) ABSTRACT

A method for determining an optimum targeted path from a source user to a target user across social networks includes classifying users connected to the source user into source positive influencers, source zero influencers, and source negative influencers, classifying users connected to the target user into target positive influencers, target zero influencers, and target negative influencers, removing the source zero influencers, the source negative influencers, the target zero influencers, and the target negative influencers from pools of users, compiling a list of each combination of the source positive influencers and the target positive influencers, performing the influence analytics to determine an influence level for each the combination of the source positive influencers and the target positive influencers, assigning a weight to each the combination of the source positive influencers and the target positive influencers based on the influence level, and determining the optimum targeted path based on the weight.

### BACKGROUND

Technical Field

This application relates to the technical fields of software and/or hardware technology and, in one example embodiment, to a system and method for determining and optimizing targeted paths to reach a target user based on influence analytics.

Description of the Related Art

Social media is an interaction among people in which they create, share or exchange information and ideas in virtual communities and networks. A social network is a platform to build relationships among people who share interests, activities, backgrounds or real-life connections. The social network includes a representation of each user (e.g., a profile), his social links, and a variety of additional services. The social network service plays a key role in enabling artists, brands, businesses etc to connect with their target audience. Users of the social network may influence the artists, brands, businesses etc in a positive or in a negative manner.

It is critical for such businesses to know who their real influencers are, and how they influence their business. Today, by aggregate segmentation, social networks such as Facebook©/twitter© can share their advertisements from the businesses directly to their target segment. However, advertisements do not carry the same level of credibility as word of mouth from an influencer. Moreover, there is lacking in effectiveness and in terms of cost to find ways to the right people to reach the right segment. When trying to reach a specific user on a social network, there can be a very high number of paths to do so, and determining an appropriate path can be very computationally intensive due to the very large number of combinations. Accordingly, there remains a need for system and method for determining an optimum path from a source user to a target user that is effective in terms of impact on the target user as computationally efficient.

### SUMMARY

In view of foregoing embodiments herein provide a system for determining an optimum targeted path from a source segment to a target segment across at least one social network based on influence analytics. The system includes a memory unit that stores a database and a set of modules, and a processor that executes the set of modules. The set of modules include an influencer classifying module, an influencer listing module, an influence level analytics module, a weightage module, and an optimum targeted path determining module. The influencer classifying module classify a plurality of users connected to the source segment on the at least one social network into source positive influencers, source zero influencers, and source negative influencers based on a level of interaction with posts of the source segment. The interaction is selected from a group including (i) likes (ii) shares (iii) positive comments, (iv) negative comments and (iv) favorites.

The influencer classifying module further classify a plurality of users connected to the target segment on the at least one social network into target positive influencers, target zero influencers, and target negative influencers based on a level of interaction with posts of the target segment. The interaction is selected from a group including (i) likes (ii) shares (iii) positive comments, (iv) negative comments, and (v) favorites. The influencer listing module lists each combination of the plurality of source positive influencers and the plurality of target positive influencers. The influence level analytics module determines an influence level for each the combination of the plurality of source positive influencers and the target positive influencers based on the source positive interaction and the target positive interaction.

The weightage module calculates a weightage of each the combination of the plurality of source positive influencers and the target positive influencers based on the influence level. The optimum targeted path determining module determines the optimum targeted path from the source segment to the target segment based on the weight of each the path that includes the source segment, an optimum source positive influencer, an optimum target positive influencer, and the target segment. An influencer filtering module of the set of modules removes the source zero influencers and the source negative influencers from a pool of users connected to the source segment, and removes the target zero influencers and the target negative influencers from a pool of users connected to the target segment.

The influencer classifying module classifies the source zero influencers based on the source zero influencers not interacting with any campaign of the source segment across the at least one social network, classifies the source negative influencers based on negative comments to at least one campaign of the source segment, classifies the target zero influencers based on the target zero influencers not interacting with any campaign of the target segment across the at least one social network, classifies the target negative influencers based on negative comments to at least one campaign of the target segment.

A connection strength module of the set of modules determines connection strength for each combination of the plurality of source positive influencers and the target positive influencers. The weightage module calculates the weightage for each the combination of the plurality of source positive influencers and the target positive influencers further based on the connection strength. The optimum targeted path determining module is further configured to not reuse the optimum target path for subsequently connecting the source segment with the target segment again for a predefined time period.

In another aspect, one or more non-transitory computer readable storage mediums storing one or more sequences of instructions, which when executed by one or more processors, causes determining an optimum targeted path from a source user to a target user across at least one social network based on influence analytics, by performing steps are provided. The steps include determining a plurality of source positive influencers connected to the source user out of a list of users across the at least one social network based on a level of source positive interaction with posts of the source user, obtaining a plurality of target positive influencers connected to the target user out of a list of users across the at least one social network based on a level of target positive interaction with posts of the target user, determining a connection strength for each combination of the plurality of source positive influencers and the target positive influencers, performing the influence analytics to determine an influence level for each the combination of the plurality of source positive influencers and the target positive influencers based on the source positive interaction and the target positive interaction, assigning a weight to each path that includes the source user, a source positive influencer, a target positive influencer, and the target user based on the connection strength and the influence level, and determining the optimum targeted path from the source user to the target user via the source positive influencer, and the target positive influencer based on the weight of each the path that includes the source user, an optimum source positive influencer, san optimum target positive influencer, and the target user. The source positive interaction is selected from a group including (i) likes (ii) shares (iii) positive comments and (iv) favorites. The target positive interaction is selected from a group including (i) likes (ii) shares (iii) positive comments and (iv) favorites.

The steps further include classifying the source zero influencers based on the source zero influencers not interacting with any campaign of the source user across the at least one social network, classifying the source negative influencers based on negative comments to at least one campaign of the source user, classifying the target zero influencers based on the target zero influencers not interacting with any campaign of the target user across the at least one social network, classifies the target negative influencers based on negative comments to at least one campaign of the target user. The steps further include removing the source zero influencers and the source negative influencers from a pool of users connected to the source user, and removing the target zero influencers and the target negative influencers from a pool of users connected to the target user.

The optimum target path for subsequently connecting the source user with the target user is not reused again for a predefined time period. The steps further include providing an incentive for the optimum source positive influencer and the optimum target positive influencer to forward a message between the source user and the target user, determining a first influence level for the plurality of source positive influencers based on the source positive interaction, and determining a second influence level for the target positive influencers based on the target positive interaction. The influence level is based on the first influence level and the second influence level.

In another aspect a computer implemented method for determining an optimum targeted path from a source user to a target user across at least one social network based on influence analytics is provided. The method includes classifying a plurality of users connected to the source user on the at least one social network into source positive influencers, source zero influencers, and source negative influencers based on a level of interaction with posts of the source user, classifying a plurality of users connected to the target user on the at least one social network into target positive influencers, target zero influencers, and target negative influencers based on a level of interaction with posts of the target user, removing the source zero influencers and the source negative influencers from a pool of users connected to the source user, removing the target zero influencers and the target negative influencers from a pool of users connected to the target user, compiling a list of each combination of the plurality of source positive influencers and the plurality of target positive influencers, performing the influence analytics to determine an influence level for each the combination of the plurality of source positive influencers and the target positive influencers based on the source positive interaction and the target positive interaction, assigning a weightage to each the combination of the plurality of source positive influencers and the target positive influencers based on the influence level, and determining the optimum targeted path from the source user to the target user via the source positive influencer and the target positive influencer based on the weight of each the path that comprises the source user, an optimum source positive influencer, an optimum target positive influencer, and the target user.

The interaction is selected from a group comprising (i) likes (ii) shares (iii) positive comments, (iv) negative comments and (iv) favorites. The method further includes determining connection strength for each combination of the plurality of source positive influencers and the target positive influencers. The weightage to each the combination of the plurality of source positive influencers and the target positive influencers is further assigned based on the connection strength. The method further includes providing an incentive for the optimum source positive influencer and the optimum target positive influencer to forward a message between the source user and the target user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system view illustrates a influence analytics application interacts with one or more user group through a social network for determining and optimizing targeted paths based on influence analytics according to an embodiment herein;

FIG. 2 illustrates an exploded view of the influence analytics application of FIG. 1 according to an embodiment herein;

FIG. 3 illustrates an graphical representation of determining a targeted path between a source user and targeted user according to an embodiment herein;

FIG. 4 is a table view illustrating source zero influencers, source negative influencers, and source positive influencers who are all connected to a source user across one or more social networks according to an embodiment herein;

FIG. 5 is a table view illustrating target zero influencers, target negative influencers, and target positive influencers who are all connected to a target user across one or more social networks according to an embodiment herein;

FIG. 6 is a table view illustrating the source positive influencers, the target positive influencers, connection strengths for each combination of a positive source influencer and a positive target influencer, influence levels for each combination of a positive source influencer and a positive target influencer, and weights according to an embodiment herein;

FIG. 7 is a table view illustrating various paths and corresponding weights according to an embodiment herein;

FIGS. 8A and 8B are flow diagrams that illustrate a method for determining an optimum targeted path from a source user to a target user across at least one social network based on influence analytics according to an embodiment herein;

FIG. 9 illustrates an exploded view of the computing device according to the embodiments herein; and

FIG. 10 a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

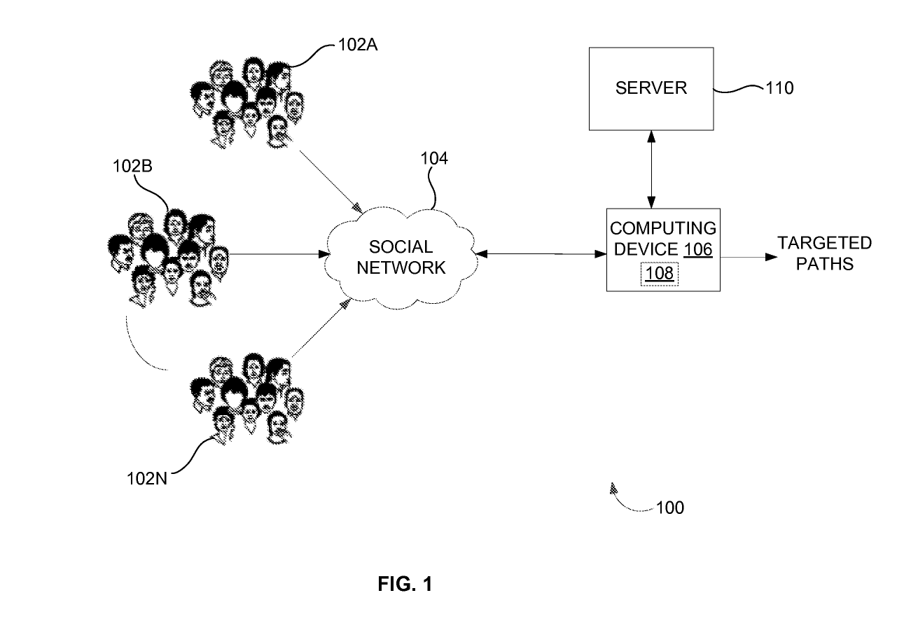

As mentioned, there remains a need for a cost effective platform which enables a process of communicating a right words to a right people or right segment. The embodiments herein achieve this by providing an influence analytics application that interacts with the one or more user group through a social network for determining and optimizing targeted paths to reach a target segment based on influence analytics. The influence analytics application determines positive influencers, avoid negative influencers, and discount zero influencers to reach target segment. Referring now to the drawings, and more particularly to FIGS. 1 through 10, where similar reference characters denote corresponding features consistently throughout the figures, there are shown preferred embodiments.

FIG. 1 is a system view 100 illustrates an influence analytics application 108 interacts with the one or more user group 102A-N through a social network 104 for determining and optimizing targeted paths based on influence analytics according to an embodiment herein. The system view 100 further includes the one or more user group 102A-N, the social network 104, the computing device 106, the influence analytics application 108, and a server 110. The one or more user group 102A-N may include a user, a customer, a seller (i.e. a source user), and a buyer (i.e. a target user). In one embodiment, the social network 104 is a social networking sites (e.g., Facebook©/twitter©). In one embodiment, the computing device 106 may be a smart device, a smart phone, a tablet PC, a laptop PC, a personal computer, and/or an ultra book.

The influence analytics application 108 may be implemented in the computing device 106 which enables an interaction between the user group 102A-N with on the social network 104. The influence analytics application 108 which support in for determining and optimizing targeted paths based on influence analytics. The influence analytics application 108 that finds a positive influencers, avoid negative influencers, discount zero influencers to reach target segment. The influence analytics application 108 obtains extensive influencer analytics data of the one or more user group 102A-N. For example influencer analytics data includes information associated with one or more people, their current associations, and their influence levels.

In one embodiment, the influencer analytics data is obtained based on trace-back, multipath and multimode probabilistic weightage method to determine influence analytics based targeted path. In one example embodiment the influence analytics application 108 is implemented in the server 110 that determines influencer levels such as a positive influencer, a negative influencer, and a zero influencer based on the influencer analytics data of the one or more user group 102A-N. For example, an advertisement associated with a sale of musical instruments is posted in the social networking sites. The number of people who give likes, comments and/or shares for the post shared is considered as the influencer analytics data.

An influencer associated with the user group 102A who like, share, comment positively about the advertisement associated with a sale of musical instruments is posted in the social networking sites are considered as the positive influencer. Similarly, the influencer associated with the user group 102B who like, share, comment negatively about the advertisement associated with a sale of musical instruments is posted in the social networking sites are considered as the negative influencers. Similarly, the influencer does not interact with post in the social network 104 are considered as the zero influencer.

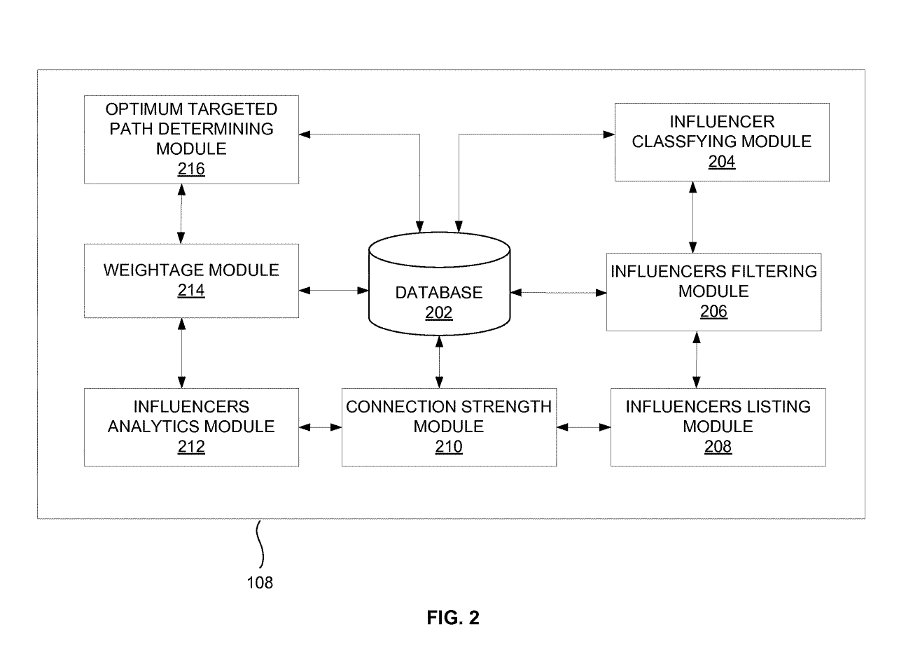

FIG. 2 illustrates an exploded view of the influence analytics application 108 of FIG. 1 according to an embodiment herein. The influence analytics application 108 includes a database 202, an influencer classifying module 204, an influencer filtering module 206, an influencer listing module 208, a connection strength module 210, an influencer analytics module 212, a weightage module 214, an optimum targeted path determining module 216, an optimum targeted path constructing module 216. The database 202 includes an influencer analytics data such as information associated with the one or more user group 102A-N. The influencer classifying module 204 that classifies one or more users connected to the source segment on the at least one social network 104 into source positive influencers, source zero influencers, and source negative influencers based on a level of interaction with posts of the source segment. The interaction is selected from the group includes (a) likes, (b) shares, (c) positive comments, (d) negative comments, and (e) favorites. The influencer classifying module 204 further classifies one or more users connected to the target segment on the at least one social network 104 into source positive influencers, source zero influencers, and source negative influencers based on a level of interaction with posts of the target segment. The influencer filtering module 206 removes the source zero influencers and the source negative influencers from a pool of users connected to the source segment. The influencer filtering module 206 further removes the target zero influencers and the target negative influencers from a pool of users connected to the target segment. The influencer listing module 208 lists each combination of the one or more source positive influencers, and the one or more target positive influencers. The connection strength module 210 determines connection strength for each combination of the one or more source positive influencers and the one or more target positive influencers. The influencers analytics module 212 determines an influence level for each the combination of the one or more source positive influencers and the one or more target positive influencers based on the source positive interaction and the target positive interaction. The weightage module 214 calculates a weightage of each the combination of the one or more source positive influencers and the one or more target positive influencers based on the influence level. The weightage module 214 calculates the weightage for each the combination of the one or more source positive influencers and the one or more target positive influencers further based on the connection strength. The optimum targeted path determining module determines the optimum path from the source segment to the target segment based on weight of each the path that includes the source segment, an optimum source positive influencer, an optimum target positive influencer, and the target segment. In one embodiment, the optimum targeted path determining module 216 is further configured to not reuse the optimum target path for subsequently connecting the source segment with the target segment again for a predefined time period. In one embodiment, the influencer classifying module 204 classifies (a) the source zero influencers based on the source zero influencers not interacting with any campaign of the source segment across the at least one social network 104, (b) the source negative influencers based on negative comments to at least one campaign of the source segment, (c) the target zero influencers based on the target zero influencers not interacting with any campaign of the target segment across the at least one social network 104, and (d) the target negative influencers based on negative comments to at least one campaign of the target segment.

The influence analytics application 108 further includes an influence level analytics module (not shown in the FIG. 2) that determines an influence level for each combination of the source positive influencers and the positive influencers based on the source positive interaction and the target positive interaction. The influence level analytics module further determines a first influence level for the source positive influencers based on the source positive interaction, and determines a second influence level for the target positive influencers based on the target positive interaction. The influence level is determined based on the first influence level and the second influence level.

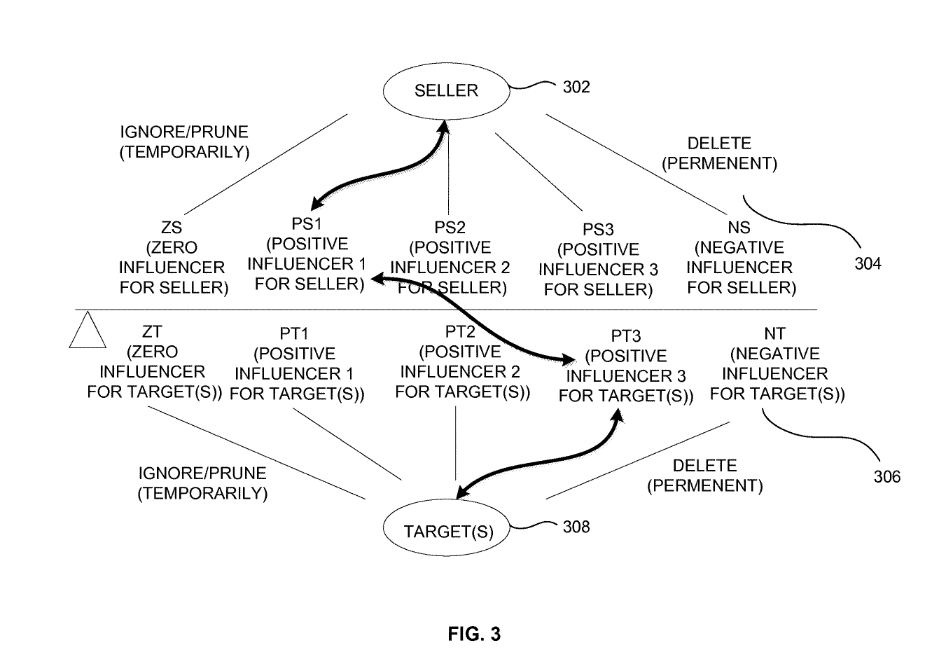

FIG. 3 illustrates a graphical representation of obtaining an influence analytics based targeted path between a source user and a targeted user according to an embodiment herein. The graphical representation 300 includes a seller 302, a source positive influencer level associated with the seller 304, a target positive influencer level associated with targeted user 306, and a target 308. The influence analytics application 108 which support in determining the influence analytics based targeted path (e.g., positive influencers, avoid negative influencers, discount zero influencers to reach the target user). The extensive analytics of data of the people, their current associations, their influence levels we can find the right influencers and optimize the target paths to the target audience.

For example, a seller 302 wants to reach target segment of people referred to as target T 308 in social networking platform (Facebook©/twitter©). An advertisement associated with a sale of musical instruments is posted in the social networking sites. Weights are assigned to one or more influencers based on classifying the one or more user group 102A-N into zero with zero weighted points, negative influencers with negative weighted points, positive influencers with positive weighted points based on their influence level. The influencers who have not responded (like, share, comment in the post) ever to the seller campaign (the advertisement associated with a sale of musical instruments) then prune them as zero influencers. Then the influencers who have shared/comments positively to the seller campaign then considered as the positive influencers. The influencers who have shared/comments negatively to the seller campaign then considered as the negative influencers. Similarly, the remaining list of the people filtered through at least one of (i) weightage to number of likes/number of posts, (ii) number of comments to number of posts, and (iii) number of good/number of bad. Based on the weightage a rank is given as the positive influencers of the seller 302.

Similarly, a set of targets that the seller may likely to target for seller campaign. The process which includes a target group is classified as based on at least one of (i) a target(s) whomsoever are connected but never responded to the posts of their friends and named as zero influencers, (ii) a target(s) whomsoever are connected but target group responded to the posts of their negatively are named as negative influencers, and (iii) specifically weightage to (a) number of likes/number of posts, (b) number of comments to number of posts, (c) number of good/number of bad done by target group for various connected influencers. Based on the weightage, top influencers are ranked that who can influence a particular targeted people or segment. Then weightage are assigned to paths Seller-PSx-PTy-Target each of these paths based on the influence level strength. Then, based on a round-robin model, strongest links between PTx group and PSx group are identified. The target paths of influence are completed based on the influencers which are connected deeply. Referring to the FIG. 3, a positive seller (PS1) might be strongly connected to a positive target (PT3) hence the target path is Seller-PS1-PT3-Target.

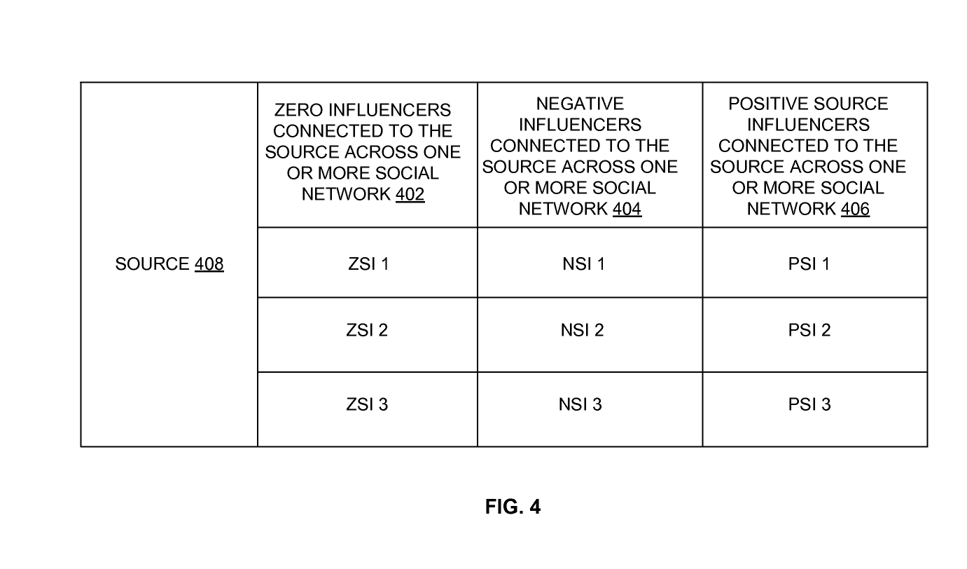

FIG. 4 is a table view illustrating zero influencers 402, negative influencers 404, and positive source influencers 406 who are all connected to a source 408 across one or more social networks according to an embodiment. Examples of the zero influencers 402 include zero source influencers 1 (ZSI 1), ZSI 2, and ZSI 3. Examples of the negative influencers 404 include negative source influencers 1 (NSI 1), NSI 2, and NSI 3. Examples of the positive source influencers 406 include positive source influencers 1 (PSI 1), PSI 2, and PSI 3.

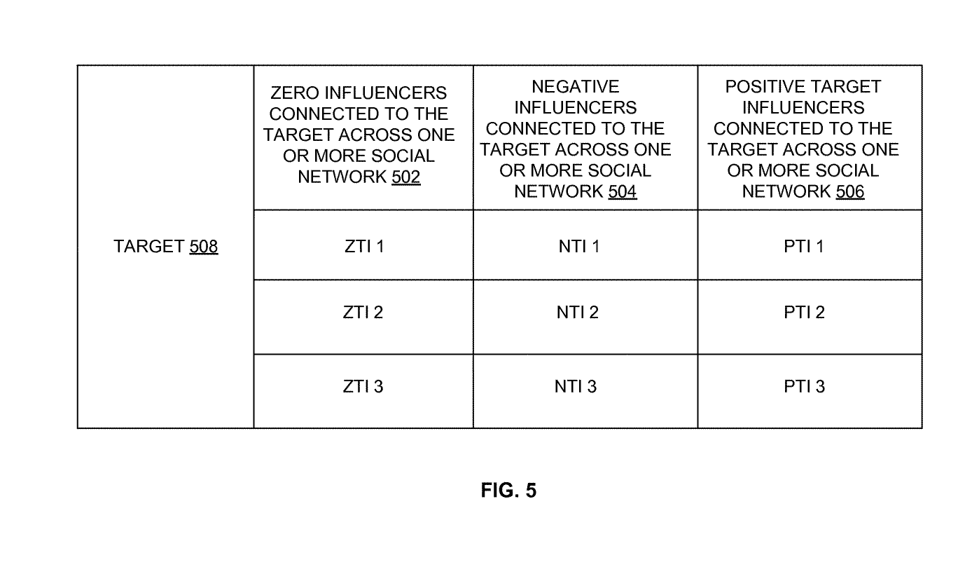

FIG. 5 is a table view illustrating zero influencers 502, negative influencers 504, and positive target influencers 506 who are all connected to a target 508 across one or more social networks according to an embodiment. Examples of the zero influencers 502 include zero target influencers 1 (ZTI 1), ZTI 2, and ZTI 3. Examples of the negative influencers 504 include negative target influencers 1 (NTI 1), NTI 2, and NTI 3. Examples of the positive target influencers 506 include positive target influencers 1 (PTI 1), PTI 2, and PTI 3.

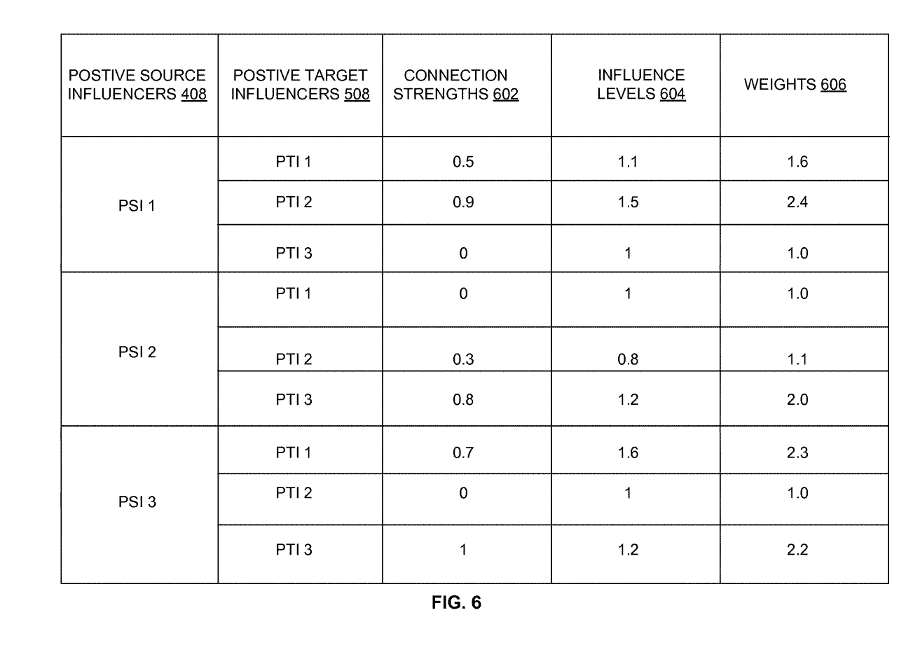

FIG. 6 is a table view illustrating the positive source influencers 406, the positive target influencers 506, connection strengths 602 for each combination of a positive source influencer and a positive target influencer, influence levels 604 for each combination of a positive source influencer and a positive target influencer, and weights 606 according to an embodiment. For example, connection strength of the PSI 1 and PTI 1 is 0.5, a connection strength of the PSI 1 and PTI 2 is 0.9, and a connection strength of the PSI 1 and PTI 3 is 0 (i.e., PSI 1 and PTI 3 are connected to each other on any social networks). Similarly, connection strengths of PSI 2 with PTI 1, PTI 2, and PTI 3, and connection strengths of PSI 3 with PTI 1, PTI 2, and PTI 3 are given in the table.

In an embodiment, an influence level of a combination of a positive source influencer and a positive target influencer is determined based on a source positive interaction (i.e., a number of likes, shares, positive comments, and/or favorites for posts posted by the source 408 by the positive source influencer), and a target positive interaction (i.e., a number of likes, shares, positive comments, and/or favorites for posts posted by the target 508 by the positive target influencer). For example, an influence level associated with a combination of PSI 1 and PTI 1 is 1.1, an influence level associated with a combination of PSI 1 and PTI 2 is 1.5, and an influence level associated with a combination of PSI 1 and PTI 3 is 1.0. Similarly, influence levels of PSI 2 with PTI 1, PTI 2, and PTI 3, and connection strengths of PSI 3 with PTI 1, PTI 2, and PTI 3 are given in the table. In one embodiment, a weight 606 of each path is determined based on connection strength and an influence level. For example, a weight of a path from the source 408 to PSI 1, from PSI 1 to PTI 1, from PTI 1 to the target 508 is 1.6, which is determined based on a connection strength (i.e., 0.5) and an influence level (i.e., 1.1) for the combination of PSI 1 and PTI 1. Similarly, for other paths the weights are determined as shown in the FIG. 6.

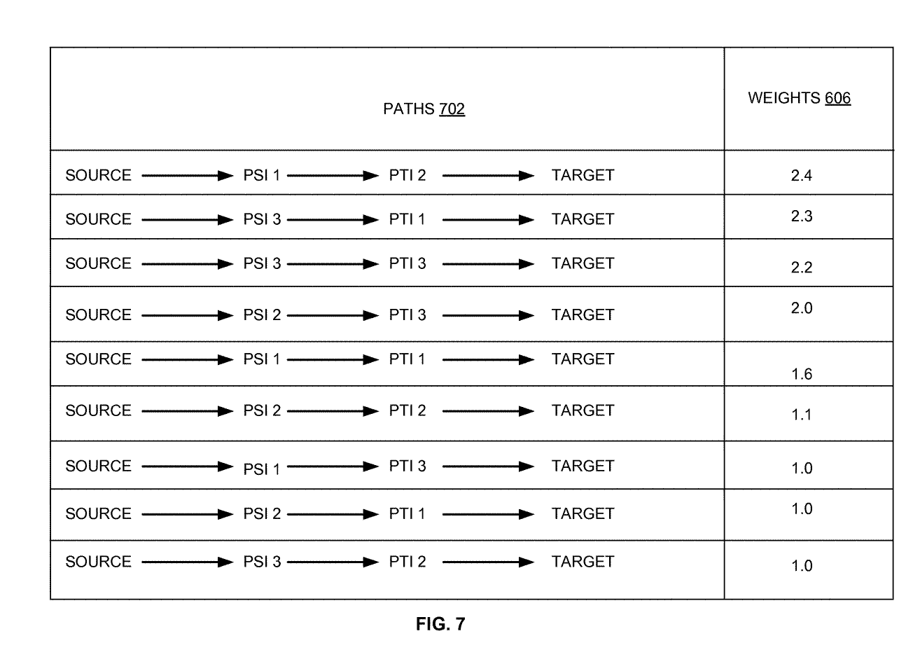

FIG. 7 is a table view illustrating various paths 702 and corresponding weights 606 according to an embodiment herein. From the FIG. 7, it is understood that an optimum path from the source 408 to the target 508 is through PSI 1 and PTI 2. The weights 606 indicate an order of an optimum path from the source 408 to the target 508.

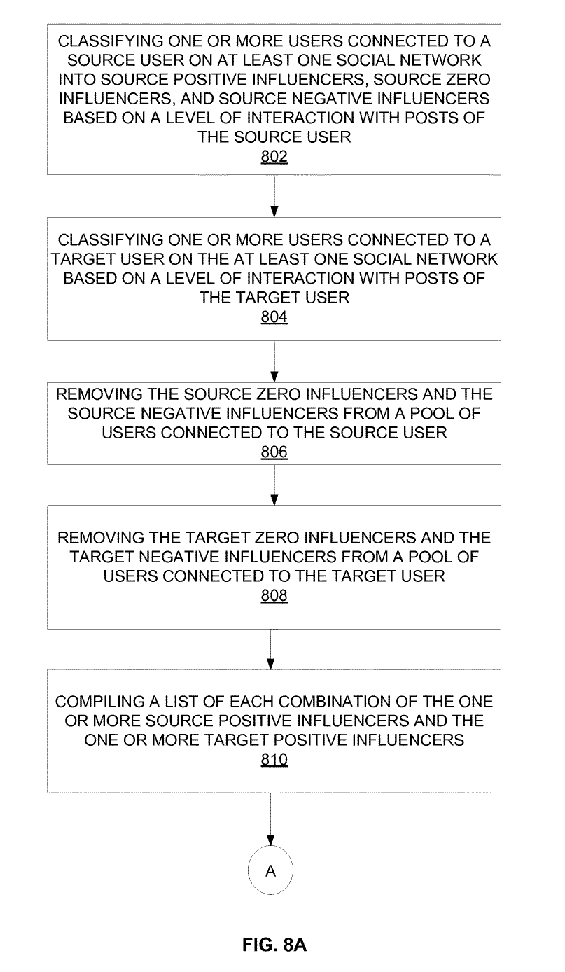

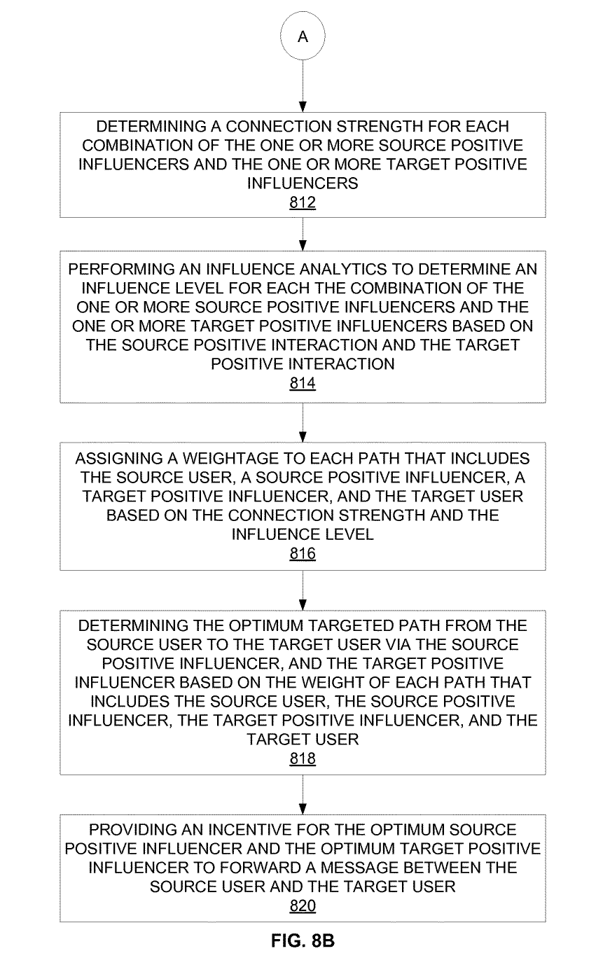

FIG. 8A-8B are flow diagrams that illustrate a method for determining an optimum targeted path from a source user to a target user across at least one social network based on influence analytics according to an embodiment herein. At step 802, one or more users connected to a source user on at least one social network are classified into source positive influencers, source zero influencers, and source negative influencers based on a level of interaction with posts of the source user. In one embodiment, the interaction is selected from the group includes (a) likes, (b) shares, (c) positive comments, (d) negative comments, and (e) favorites. At step 804, one or more users connected to a target user on the at least one social network are classified into source positive influencers, source zero influencers, and source negative influencers based on a level of interaction with posts of the target user. At step 806, source zero influencers and the source negative influencers are removed from a pool of users connected to the source user. At step 808, the target zero influencers and the target negative influencers are removed from a pool of users connected to the target user. At step 810, a list of each combination of the one or more source positive influencers and the one or more target positive influencers is compiled. At step 812, a connection strength for each combination of the one or more source positive influencers and the one or more target positive influencers is determined. At step 814, an influence analytics is performed to determine an influence level for each the combination of the one or more source positive influencers and the one or more target positive influencers based on the source positive interaction and the target positive interaction. At step 816, a weightage is assigned to each path that includes the source user, a source positive influencer, a target positive influencer, and the target user based on the connection strength and the influence level. At step 818, the optimum targeted path is determined from the source user to the target user via the source positive influencer, and the target positive influencer based on the weight of each path that includes the source user, the source positive influencer, the target positive influencer, and the target user. At step 820, an incentive for the optimum source positive influencer and the optimum target positive influencer is provided to forward a message between the source user to the target user.

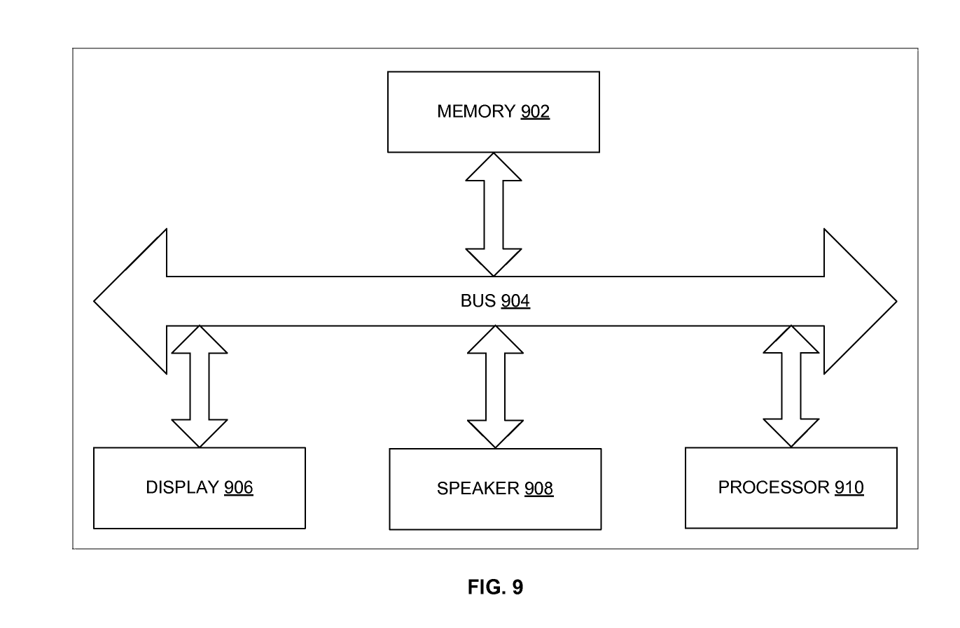

FIG. 9 illustrates an exploded view of the computing device 106 having an a memory 902 having a set of computer instructions, a bus 904, a display 906, a speaker 908, and a processor 910 capable of processing a set of instructions to perform any one or more of the methodologies herein, according to an embodiment herein. In one embodiment, the receiver may be the computing device 106. The processor 910 may also enable digital content to be consumed in the form of video for output via one or more displays 906 or audio for output via speaker and/or earphones 908. The processor 910 may also carry out the methods described herein and in accordance with the embodiments herein.

Digital content may also be stored in the memory 902 for future processing or consumption. The memory 902 may also store program specific information and/or service information (PSI/SI), including information about digital content (e.g., the detected information bits) available in the future or stored from the past. A user of the computing device 106 may view this stored information on display 906 and select an item of for viewing, listening, or other uses via input, which may take the form of keypad, scroll, or other input device(s) or combinations thereof. When digital content is selected, the processor 910 may pass information. The content and PSI/SI may be passed among functions within the computing device 106 using the bus 904.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

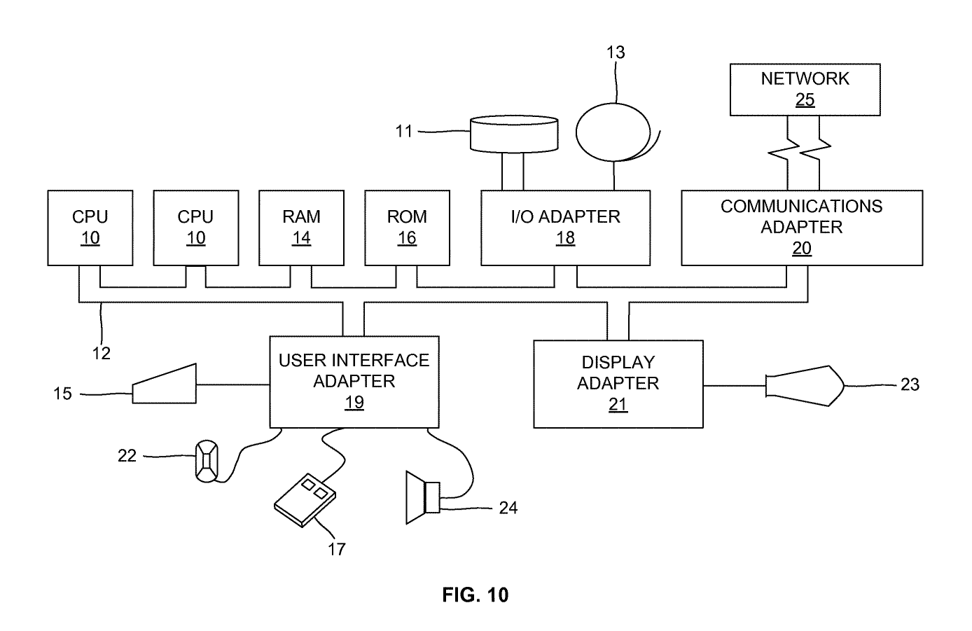

A representative hardware environment for practicing the embodiments herein is depicted in FIG. 10. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The influence analytics application 108 helps to know who are the positive, negative, and zero influencers across the social network. The implementation which have low-cost in terms of computation, bandwidth, and storage model. There exists a great bandwidth/storage/calculation capacity for performing next round of calculations by removing the negative influencers in an efficient way. The seller and buyer can be in different network as the message carries the link back to the seller. The next strongest connection can be found, so that the same optimal routes are not used. The influence analytics application 108 helps in targeting a particular segment and not only a particular user (segment targeting).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

1. A system for determining an optimum targeted path from a source segment to a target segment across at least one social network based on influence analytics, said system comprising:
a memory unit that stores a database and a set of modules;
a processor that executes said set of modules, wherein said set of modules comprise:
an influencer classifying module, executed by said processor, that is configured to:
classify a plurality of users connected to said source segment on said at least one social network into source positive influencers, source zero influencers, and source negative influencers based on a level of interaction with posts of said source segment, wherein said interaction is selected from a group comprising (i) likes (ii) shares (iii) positive comments. (iv) negative comments and (iv) favorites; and
classify a plurality of users connected to said target segment on said at least one social network into target positive influencers, target zero influencers, and target negative influencers based on a level of interaction with posts of said target segment, wherein said interaction is selected from a group comprising (i) likes (ii) shares (iii) positive comments, (iv) negative comments, and (v) favorites;
an influencer listing module, executed by said processor, that lists each combination of said plurality of source positive influencers and said plurality of target positive influencers;
an influence level analytics module, executed by said processor, that determines an influence level for each said combination of said plurality of source positive influencers and said plurality of target positive influencers based on said source positive interaction and said target positive interaction;
a weightage module, executed by said processor, that calculates a weightage of each said combination of said plurality of source positive influencers and said plurality of target positive influencers based on said influence level; and
an optimum targeted path determining module, executed by said processor that determines said optimum targeted path from said source segment to said target segment based on said weight of each said path that comprises said source segment, an optimum source positive influencer, an optimum target positive influencer, and said target segment.

2. The system of claim 1, further comprising an influencer filtering module, executed by said processor, that is configured to:
remove said source zero influencers and said source negative influencers from a pool of users connected to said source segment; and
remove said target zero influencers and said target negative influencers from a pool of users connected to said target segment.

3. The system of claim 1, wherein said influencer classifying module classifies said source zero influencers based on said source zero influencers not interacting with any campaign of said source segment across said at least one social network, classifies said source negative influencers based on negative comments to at least one campaign of said source segment, classifies said target zero influencers based on said target zero influencers not interacting with any campaign of said target segment across said at least one social network, classifies said target negative influencers based on negative comments to at least one campaign of said target segment.

4. The system of claim 1, further comprising a connection strength module, executed by said processor, that determines a connection strength for each combination of said plurality of source positive influencers and said target positive influencers, wherein said weightage module calculates said weightage for each said combination of said plurality of source positive influencers and said target positive influencers further based on said connection strength.

5. The system of claim 1, wherein said optimum targeted path determining module is further configured to not reuse said optimum target path for subsequently connecting said source segment with said target segment again for a predefined time period.

6. One or more non-transitory computer readable storage mediums storing one or more sequences of instructions, which when executed by one or more processors, causes determining an optimum targeted path from a source user to a target user across at least one social network based on influence analytics, by performing the steps of:
determining a plurality of source positive influencers connected to said source user out of a list of users across said at least one social network based on a level of source positive interaction with posts of said source user, wherein said source positive interaction is selected from a group comprising (i) likes (ii) shares (iii) positive comments and (iv) favorites;
obtaining a plurality of target positive influencers connected to said target user out of a list of users across said at least one social network based on a level of target positive interaction with posts of said target user, wherein said target positive interaction is selected from a group comprising (i) likes (ii) shares (iii) positive comments and (iv) favorites;
determining a connection strength for each combination of said plurality of source positive influencers and said target positive influencers;
performing said influence analytics to determine an influence level for each said combination of said plurality of source positive influencers and said target positive influencers based on said source positive interaction and said target positive interaction;
assigning a weight to each path that comprises said source user, a source positive influencer, a target positive influencer, and said target user based on said connection strength and said influence level; and
determining said optimum targeted path from said source user to said target user via said source positive influencer, and said target positive influencer based on said weight of each said path that comprises said source user, an optimum source positive influencer, an optimum target positive influencer, and said target user.

7. The one or more non-transitory computer readable storage mediums storing one or more sequences of instructions of claim 6, which when executed by said one or more processors further causes:
classifying said source zero influencers based on said source zero influencers not interacting with any campaign of said source user across said at least one social network;
classifying said source negative influencers based on negative comments to at least one campaign of said source user;
classifying said target zero influencers based on said target zero influencers not interacting with any campaign of said target user across said at least one social network; and
classifies said target negative influencers based on negative comments to at least one campaign of said target user.

8. The one or more non-transitory computer readable storage mediums storing one or more sequences of instructions of claim 6, which when executed by said one or more processors further causes:
removing said source zero influencers and said source negative influencers from a pool of users connected to said source user; and
removing said target zero influencers and said target negative influencers from a pool of users connected to said target user.

9. The one or more non-transitory computer readable storage mediums storing one or more sequences of instructions of claim 6, which when executed by said one or more processors further causes not reusing said optimum target path for subsequently connecting said source user with said target user again for a predefined time period.

10. The one or more non-transitory computer readable storage mediums storing one or more sequences of instructions of claim 6, which when executed by said one or more processors further causes providing an incentive for said optimum source positive influencer and said optimum target positive influencer to forward a message between said source user and said target user.

11. The one or more non-transitory computer readable storage mediums storing one or more sequences of instructions of claim 6, executed by said one or more processors, wherein said influence analytics comprises:
determining a first influence level for said plurality of source positive influencers based on said source positive interaction; and
determining a second influence level for said target positive influencers based on said target positive interaction,
wherein said influence level is based on said first influence level and said second influence level.

12. A computer implemented method for determining an optimum targeted path from a source user to a target user across at least one social network based on influence analytics, said method comprising:
classifying a plurality of users connected to said source user on said at least one social network into source positive influencers, source zero influencers, and source negative influencers based on a level of interaction with posts of said source user, wherein said interaction is selected from a group comprising (i) likes (ii) shares (iii) positive comments, (iv) negative comments and (iv) favorites;
classifying a plurality of users connected to said target user on said at least one social network into target positive influencers, target zero influencers, and target negative influencers based on a level of interaction with posts of said target user, wherein said interaction is selected from a group comprising (i) likes (ii) shares (iii) positive comments, (iv) negative comments and (iv) favorites;
removing said source zero influencers and said source negative influencers from a pool of users connected to said source user;
removing said target zero influencers and said target negative influencers from a pool of users connected to said target user;
compiling a list of each combination of said plurality of source positive influencers and said plurality of target positive influencers;
performing said influence analytics to determine an influence level for each said combination of said plurality of source positive influencers and said target positive influencers based on said source positive interaction and said target positive interaction;
assigning a weightage to each said combination of said plurality of source positive influencers and said target positive influencers based on said influence level; and
determining said optimum targeted path from said source user to said target user via said source positive influencer and said target positive influencer based on said weight of each said path that comprises said source user, an optimum source positive influencer, an optimum target positive influencer, and said target user.

13. The computer implemented method of claim 12, further comprising determining a connection strength for each combination of said plurality of source positive influencers and said target positive influencers, wherein said weightage to each said combination of said plurality of source positive influencers and said target positive influencers is further assigned based on said connection strength.

14. The computer implemented method of claim 12, further comprising providing an incentive for said optimum source positive influencer and said optimum target positive influencer to forward a message between said source user and said target user.
